(19) United States
(12) Patent Application Publication
(10) Pub. No.: US 2006/0053029 A1
(43) Pub. Date: Mar. 9, 2006

(54) Methods and systems for providing an enterprise supply management portal

(76) Inventor: Keith R. Butler, Herndon, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/217,622

(22) Filed: Sep. 1, 2005

Related U.S. Application Data
(60) Provisional application No. 60/606,900, filed on Sep. 3, 2004.

(51) Int. Cl. G06Q 99/00; G05B 19/418

(52) U.S. Cl. 705/1; 705/8

(57) ABSTRACT

Exemplary systems and methods for providing an enterprise supply management portal are disclosed. The enterprise supply management portal of the present invention may provide an efficient, easy to use, and reliable system for suppliers and enterprise personnel to conduct business over, for example, a web-based platform. This platform may transform a supply management work process into a completely online work environment and community, thereby reducing the need for paper transactions.

### PRIORITY

Under provisions of 35 U.S.C. §119(e), this Application claims the benefit of U.S. Provisional Application No. 60/606,900 filed Sep. 3, 2004, which is incorporated herein in its entirety by reference.

### TECHNICAL FIELD

Disclosed herein is a method and system for managing suppliers of products and services. More particularly, there is disclosed an enterprise supply management portal that can provide interactive, online management of products and services for suppliers and enterprise personnel.

### BACKGROUND

The United States Postal Service (USPS™) is an independent establishment of the United States government that provides mail delivery and other services to the public. The USPS™ is widely recognized as a safe and reliable means for sending and receiving mail and other delivery items. With the advent and steady growth of electronic commerce, the physical delivery stream will increasingly be utilized for sending and receiving mail pieces, packages, and other items. Accordingly, providers of delivery service such as the USPS™ will continue to require better systems and methods to meet the increasing demand for faster, more efficient and reliable delivery of mail and other delivery items.

Currently, the USPS™ has the enormous task of overseeing hundreds of thousands of mail carriers who daily deliver approximately 617 million delivery items to about 141 million delivery points throughout the nation. Like many large enterprises, the USPS™ may rely on products and support services provided by outside contractors or suppliers to accomplish its business goals. To facilitate the management of these suppliers or contractors, enterprises such as the USPS™ may utilize a supply management work process. However, conventional supply management work processes that are based, for example, on paper, telephone calls, and faxes for data communication, collection and retrieval can create great inefficiencies. For example, conventional processes can be error-prone due to mishandling by human interaction, may involve significant time delays between communications, and may not allow for a completely online work environment and community.

Accordingly, new methods and systems for efficient and reliable data communication, collection and retrieval between the enterprise and the suppliers are desired. There is thus a need for an enterprise supply management portal that can facilitate the management of products and service suppliers for an enterprise. This portal may, for example, provide an online “one-stop-shop” for the convenience of suppliers and enterprise personnel.

### SUMMARY

Consistent with the present invention, systems and methods are disclosed for providing an enterprise supply management portal.

Embodiments provide exemplary systems and methods for providing an enterprise supply management portal. For example, embodiments may provide a “one-stop-shop” for suppliers and enterprise personnel to collaborate over, for example, a web-based platform. This platform may transform a supply management work process from being based, for example, on paper, telephone calls, and faxes, to a completely online work environment and community.

In accordance with one embodiment, a method is provided for managing an enterprise supply. The method comprises providing an enterprise management supply portal comprising an eCommerce module, a strategic sourcing module, a collaboration access module, supplier relationship management module, and a business intelligence module. The method further comprises using the eCommerce module, the eCommerce module being configured to use a plurality of sub-modules to provide an integrated application environment. The method also involves using the strategic sourcing module, the strategic sourcing module being configured to provide decision support and analysis. The method involves using the collaboration access module as well, the collaboration access module being configured to provide integrated voice and speech recognition. Further, the method involves using the supplier relationship management module, where the supplier relationship management module is configured to provide supplier relationship management between a supplier and an enterprise. And, the method involves using the business intelligence module, the business intelligence module being configured to provide management of documents and content within the enterprise supply management portal.

In accordance with another embodiment, a system is provided for enterprise supply management. The system comprises an enterprise supply management portal. The portal comprises a memory storage for maintaining a database and a processing unit coupled to the memory storage. An eCommerce module is provided for use with the processing unit. The e-commerce module can be configured to use a plurality of sub-modules to provide an integrated application environment. A strategic sourcing module can also provided for use with the processing unit, the strategic sourcing module being configured to provide decision support and analysis. A collaboration access module can be provided for use with the processing unit as well, the collaboration access module being configured to provide integrated voice and speech recognition. Further, a supplier relationship management module can be provided for use with the processing unit. The supplier relationship management module can be configured to provide supplier relationship management between a supplier and an enterprise. And, a business intelligence module can be provided for use with the processing unit. The business intelligence module can be configured to provide management of documents and content within the enterprise supply management portal.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a diagram representing an architecture of an exemplary enterprise supply management portal consistent with the present invention;

FIG. 2 is a block diagram of an enterprise supply management portal providing system consistent with the present invention; and

FIG. 3 is a flow chart of an exemplary method for providing an enterprise supply management portal consistent with the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

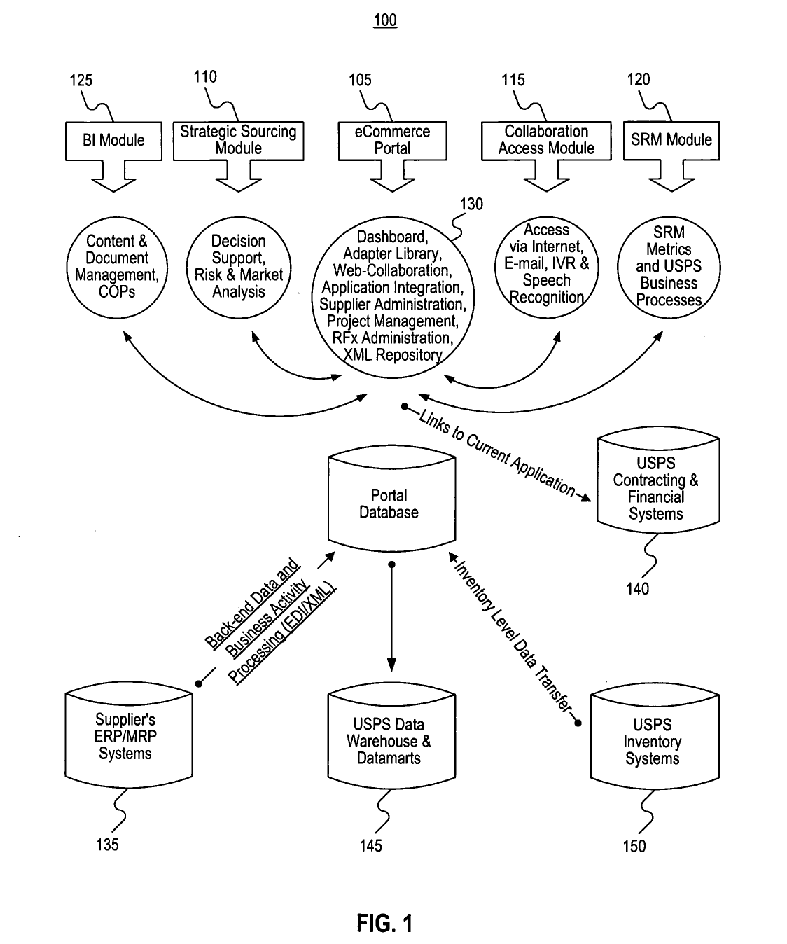

Embodiments provide exemplary systems and methods for providing an enterprise supply management portal. For example, embodiments may provide a “one-stop-shop” for suppliers and enterprise personnel to collaborate over, for example, a web-based platform. This platform may transform a supply management work process from being based, for example, on paper, telephone calls, and faxes, to a completely online work environment and community. As shown in FIG. 1, an exemplary enterprise supply management portal 100 consistent with the present invention is provided. Portal 100 may include modules that may provide or enhance, for example, an online supply management work process. The modules may include, but are not limited to: i) an eCommerce module 105 (for example, the engine of portal); ii) a strategic sourcing module 110; iii) a collaboration access module 115; iv) a supplier relationship management module 120; v) and a business intelligence module 125. These modules may help streamline the supply management work process within, for example, contracting teams within an enterprise. Each of the above modules is described in greater detail below.

Portal 100 may be considered a “one-stop-shop” for product and service suppliers and enterprise personnel to collaborate over, for example, the Internet. Portal 100 may allow the suppliers and the enterprise personnel to coordinate requests and demands for products or supplies within an interactive, online community. Portal 100 may significantly reduce the costs of conventional enterprise contract lifecycle management and supplier relationship management by leveraging, for example, best-in-class commercial-off-the-shelf (COTS) solutions. Furthermore, portal 100 may reduce supplier's cost to do business with the enterprise by streamlining the interactions required to reach a business solution between the supplier and the enterprise. This streamlined process may prove beneficial for both suppliers and the enterprise, and help reduce the enterprise's procurement costs.

In an exemplary embodiment, a system provides a portal 100. The system may comprise a memory storage for maintaining a database and a processing unit coupled to the memory storage. The processing unit may be operative to use an eCommerce module configured to use a plurality of sub-modules to provide an integrated application environment. In addition, the processing unit may be operative to use a strategic sourcing module configured to provide decision support and analysis. Also, the processing unit may be operative to use a collaboration access module configured to provide integrated voice and speech recognition. Moreover, the processing unit may be operative to use a supplier relationship management module configured to provide supplier relationship management between a supplier and an enterprise. Furthermore, the processing unit may be operative to use a business intelligence module configured to provide management of documents and content within the portal 100.

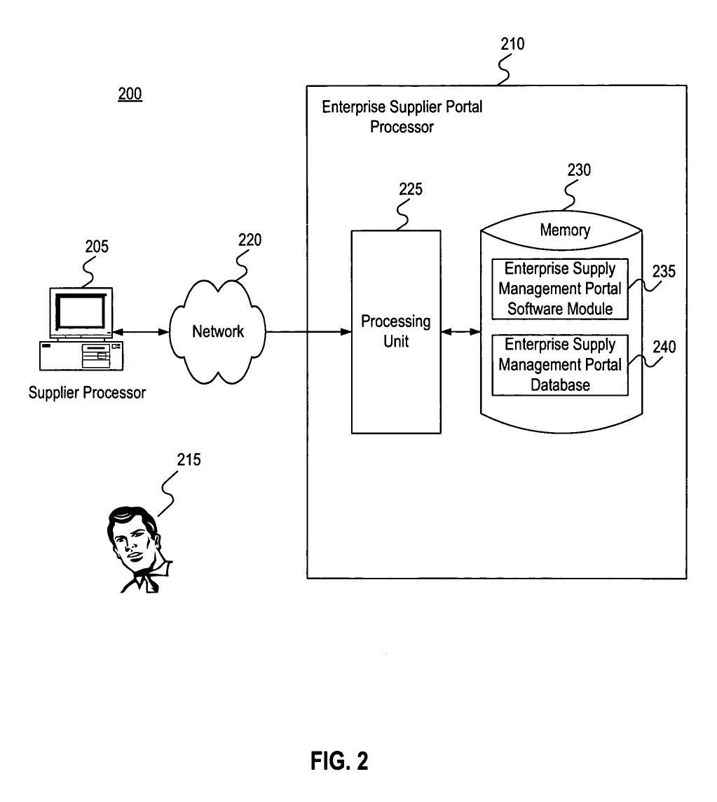

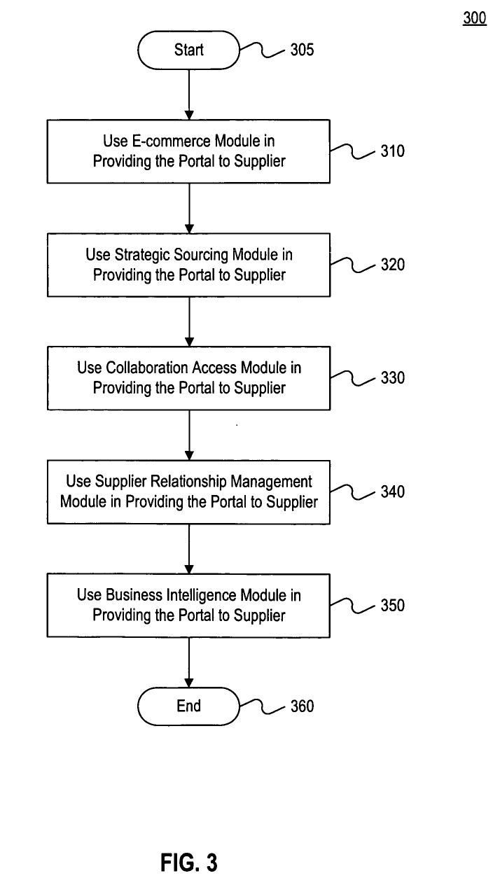

Consistent with the present invention, the aforementioned memory, processing unit, and other components may be implemented in a portal providing system, such as an exemplary system 200 as shown in FIG. 2. Any suitable combination of hardware, software and/or firmware may be used to implement the memory, processing unit, or other components. By way of example, the memory, processing unit, or other components may be implemented with any of a portal processor 210 or a supplier processor 205, in combination with system 200, as described below with respect to FIG. 3. The aforementioned system and processors are exemplary and other systems and processors may comprise the aforementioned memory, processing unit, or other components, consistent with the present invention.

Furthermore, any system or component of the embodiments may be practiced in an electrical circuit comprising discrete electronic elements, packaged or integrated electronic chips containing logic gates, a circuit utilizing a microprocessor, or on a single chip containing electronic elements or microprocessors. The embodiments may also be practiced using other technologies capable of performing logical operations such as, for example, AND, OR, and NOT, including but not limited to mechanical, optical, fluidic, and quantum technologies. In addition, the embodiments may be practiced within a general purpose computer or in any other circuit or system.

As shown in FIG. 2, processor 210 may comprise a memory storage 230 for maintaining a database (or databases) and a processing unit 225 coupled to memory storage 230. Memory storage 230, processing unit 225, or other components of processor 210 may be implemented in combination with system 200. The aforementioned system and processor are exemplary and other systems and processors may comprise the aforementioned memory, processing unit, or other components, consistent with the present invention.

As illustrated in the block diagram of FIG. 2, system 200 may include a supplier 215, processors 205 and 210, and a network 220. Processor 210 may include processing unit 225 and memory 230. Memory 230 may include a portal software module 235 and a portal database 240. Moreover, software module 235 may include sub-modules such as eCommerce module 105, strategic sourcing module 110, collaboration access module 115, supplier relationship management module 120, and business intelligence module 125. For example, software module 235, executed on processing unit 225, may access database 240 and implement processes for providing a portal 100 such as the method described below with respect to FIG. 3.

Processors 205 and 210, or any other processor or component included in system 200 (generally referred to hereafter as “the processors”), may be implemented using a personal computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 220 may comprise, for example, a local area network (LAN) or a wide area network (WAN). Such networking environments are commonplace in offices, enterprise-wide computer networks, intranets, and the Internet, and are known by those skilled in the art. When a LAN is used as network 220, a network interface located at any of the processors may be used to interconnect any of the processors. When network 220 is implemented in a WAN networking environment, such as the Internet, the processors may typically include an internal or external modem (not shown) or other means for establishing communications over the WAN. Further, in utilizing network 220, data sent over network 220 may be encrypted to insure data security by using known encryption/decryption techniques.

In addition to utilizing a wire line communications system as network 220, a wireless communications system, or a combination of wire line and wireless systems may be utilized with network 220 in order to, for example, exchange web pages via the Internet, exchange e-mails via the Internet, or for utilizing other communications channels. Wireless communication can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 200 may also transmit data by methods and processes other than, or in combination, with network 220. These methods and processes may include, but are not limited to, transferring data via diskette, CD ROM, flash memory sticks, facsimile, conventional mail, an interactive voice response system (IVR), or via voice over a publicly switched telephone network, electronic data interchange (EDI), or web services, such as for example, XML or simple object access protocol (SOAP).

FIG. 3 is a flow chart setting forth the general stages involved in an exemplary method 300 consistent with the invention for providing a portal 100 using system 200 of FIG. 2. Exemplary ways to implement the stages of method 300 will be described in greater detail below. Method 300 may begin at starting block 305 and proceed to stage 310 where portal processor 210 may execute software module 235 that may use eCommerce module 105 in providing portal 100 to supplier 215. eCommerce module 105 may include a plurality of eCommerce processes 130 that may, for example, form the “one-stop-shop” environment for suppliers and enterprise personnel. A first process may comprise a tool that may allow contracting officers with the enterprise to post requests for proposal (RFP) documents, as well as any other documents, on portal 100 for suppliers to view online anytime. A second process may comprise a “dashboard” (or a series of “portlets”) that may allow suppliers and contracting officers to view their activity within the portal environment. This activity may include: current contract status; contract lifecycle management; links to forward and reverse auction bidding tools; and current contract financial status (billing, invoicing, advanced ship notices, etc.). A third process may comprise a tool that may allow suppliers to self-register with portal 100 and create their own account. The account may be defined by information that the supplier's personnel may give upon registration, as well as voiceprint identification for security purposes. Also, the account may allow better supplier administration by enterprise personnel through portal 100.

A fourth process within ecommerce processes 130 may comprise a tool that may facilitate, for example, web-based collaboration. This collaboration may support threaded discussions and instant messaging, as well as a discussion archive. A fifth process may comprise a contract/project management tool that may allow both suppliers and authorized enterprise personnel to view, set, edit, and delete milestones and timelines that may show the activities supporting the contract. A sixth process may comprise an XML repository and adaptor library in a portal engine that may archive portal activity and data, and may allow portal 100 to be linked to other applications 135, 140, 145, and 150. A seventh process may comprise application integration and may be tied into the XML repository. In order to have seamless integration of data, the adaptor library may be used to unify the portal's metadata, ontology, and taxonomies with other applications so that data flow may be strong and easy to maintain. It is understood that eCommerce module 105 may include other processes and is not limited to those listed above.

As shown in FIG. 1, portal 100 may be linked to other applications to interface with and share data with a portal database. These other applications may include, for example, an application to a supplier's enterprise resource planning and material resource planning (ERP/MRP) systems 135; an application to a contracting and financial systems 140, such as the USPS™ contracting and financing systems; an application to a data warehouse, such as for example, the USPS™ data warehouse and datamarts 145; and, an application to an inventory system 150, such as for example, the USPS™ material distribution and inventory management system (MDIMS). Back-end data and business activity processing data may be transferred between the supplier's ERP/MRP systems 135 and portal 100 as EDI or XML data. It is contemplated that the inventory systems 150 may be contained within a mainframe that can be accessed via a web-based platform.

Contracting and financial systems 140 can comprise applications such as, for example: i) desktop reverse auction (DRA), a bid-down auction system that enables suppliers to bid on a supply or service contract, with the desired goal of awarding the contract to the lowest bidder; ii) eBuy, a database of supply catalogs from which enterprise personnel may organize, retrieve and access desired catalogs to place catalog purchase orders; iii) contract systems, which include word processor-based applications such as a Microsoft Word™ application that can be utilized to create contracts between suppliers and the enterprise; and iv) accounts payable and other financial systems. Examples of contracting systems that can be provided with the present invention include a Contract Authorizing and Management System (CAMS), Transportation Contracting Support System (TCSS), and Facilities Management System Window (FMSWin). CAMS can be utilized to create contracts between supply service and mail service providers and the enterprise, TCSS can be utilized to create contracts between transportation goods and service providers (for example, truck drivers) and the enterprise, and FMSWin can provide a web-based, modular application for creating contracts between authorized suppliers and the enterprise via, for example, the Internet.

From stage 310, where portal processor 210 uses eCommerce module 105, method 300 may advance to stage 320 where portal processor 210 may execute software module 235 that may use strategic sourcing module 110 in providing portal 100 to supplier 215. Strategic sourcing module 110 may include, for example, one or more COTS tools that can be integrated into portal 100 to perform decision support and analysis. Supplier 215 or enterprise personnel may use module 110, for example, to have full visibility of contract spend data, and to evaluate contracts through various processes to provide the most optimal configuration for a strategically sourced contract. Module 110 may allow enterprise personnel, such as contracting officers and their teams, for example, to perform various analyses of their contracts and suppliers. Moreover, module 110 may allow enterprise personnel to perform tests on what contract configurations would optimize strategic sourcing and spend. Also, supplier risk and market risk can be analyzed to find trends in both topics, and to determine if current enterprise suppliers could be harmed by potential changes in their markets.

After portal processor 210 uses strategic sourcing module 110 in stage 320, method 300 may proceed to stage 330 where processor 210 may execute software module 235 that may use collaboration access module 115 in providing portal 100 to supplier 215. For instance, collaboration access module 115 may include, for example, one or more COTS tools that can be integrated into portal 100 to allow, for example, interactive voice response (IVR) and speech recognition. IVR access, for example, may help those suppliers who do not have internet access to interact and collaborate with portal 100 through an IVR and speech recognition system. For example, collaboration access module 115 may use VoiceXML technology that may feed IVR and speech data directly into the an XML repository or database associated with portal 100. It is contemplated that that the integration of voice or speech data transfer and computer or keyed data transfer provided by the present invention offers the suppliers and the enterprise personnel utilizing portal 100 ease of use and greater flexibility in the portal's application compared to conventional management processes.

Once portal processor 210 uses collaboration access module 115 in stage 330, method 300 may proceed to stage 340 where processor 210 may execute software module 235 that may use supplier relationship management module 120 in providing portal to supplier 215. For instance, the supplier relationship management (SRM) module 120 may include one or more COTS tools that may be integrated into the portal to allow, for example, supplier relationship management between enterprise suppliers and enterprise personnel. This may allow policies, procedures, and processes mandated from enterprise purchasing policies to be embedded into, for example, the business rules, metadata, and taxonomy layers that may govern workflows and processes throughout the portal. For example, a wizard may be used to guide a contracting officer with the enterprise through stages in evaluating a supplier's performance. Alternatively, a wizard may guide enterprise personnel, looking for suppliers, based upon various supplier diversity metrics. Also, supplier diversity activities, reports, and data may be embedded into the SRM and contract lifecycle management activities of portal 100. This may allow for subcontracting management, as well as for registration of small, woman, minority, and Javitz-Wagner-O'Day (JWOD) Act-based businesses serving the enterprise in order to conform with enterprise policies or governmental regulations.

From stage 340, where portal processor 210 uses supplier relationship management module 120, method 300 may advance to stage 350 where processor 210 may execute software module 235 that may use business intelligence module 125 in providing portal 100 to supplier 215. For example, business intelligence (BI) module 125 may include one or more COTS tools that can be integrated into the portal 100 to allow, for example, management of documents and content within portal 100. The business intelligence module 125 may allow suppliers and enterprise personnel to author and edit documents based upon a set workflow, using, for example, “check-in/check-out” procedures, and within a version control environment. This may tie into the other modules within software module 235 and may allow the system to have complete knowledge of its content and all activities within the system. Furthermore, BI module 125 may be the foundation that builds, for example, communities of practice (COPs) that focus upon one or more topics. For example, a COP may be formed that focuses on contracts for utilities procurement and material management. The members of such a COP may be the supplier, the contracting officer, the personnel supporting the supplier, and contracting officer, and/or individuals from other enterprise functions who need to be involved, at some level, with the management of utilities contracts. After portal processor 210 uses business intelligence module 125 in stage 350, method 300 may then end at stage 360.

It is contemplated that the methods and systems providing portal 100 may be utilized in a variety of different manners to facilitate the coordination of business relationships between suppliers and enterprise personnel. The following are a few examples of how this coordination can be achieved with the system and portal.

In one example, a supplier may use the system and portal 100 to interact with the enterprise. For instance, a prospective or existing supplier to the USPS™ may use portal 100 to create an Enterprise Supply Management Portal (ESMP) account online by registering as a supplier. This registration step could provide them with a username and password. Going forward, the supplier may be able to access its entire account online, or most of its account via phone. The supplier may also be able to conduct transactions either online or via phone, as well as view all account information and the status of its contracts with the USPS™.

One example of an application of this process may be how a trucking company interacts with portal 100 of the present system. The supplier may log onto portal 100 either through an online username and password or via phone with a username and password. Once it is authenticated (either by TIN, SNN, voiceprint identification, or other indicators), the supplier may be provided with options to, for example, view its account, collaborate with USPS™ personnel, check the status of transactions, and exit its account.

In an exemplary scenario, the trucking company may wish to log the increase in price or usage of gas during the past month for its account. Either online or via phone, the trucking company may convey this information by indicating that the increase was, for example, $0.20 a gallon for 500 miles traveled. The system may verify this information against a data source on average gas costs along the route, and confirm the total amount. The system may then inform the supplier that the request has been received, and if confirmed by the appropriate USPS™ personnel or data source, the trucking company may receive a payment within a certain number of business days. The payment may be either a physical check mailed to an address that the supplier has specified, or an electronic fund transfer to a bank account that the supplier has specified. Accordingly, the business rules/logic of portal 100 may allow for a vast number of manual transactions such as the one previously described to be automatically processed by the system.

In another example, a contracting officer of an enterprise such as the USPS™ may use the system and portal 100 to coordinate activities with suppliers or other enterprise personnel. For example, the officer may log into portal 100 by turning on his computer at the office in the morning. The computer may be tied to the “single sign on” process that, once booted up, automatically launches a web-based browser that allows for access into portal 100. From here, the officer may be presented with a series of portlets that provide information in small sub-windows. For example, one window may show a daily “to-do” list, while another may show an event calendar. A third portlet may show, for example, the status of current contracts, a fourth may show supplier risk profiles, a fifth may show market information within their commodity focus (such as Utilities or Office Supplies). A sixth portlet may show project milestones that need to be completed for their work, and a seventh portlet may show documents that the officer is working on with other team members and suppliers.

The officer may utilize the system through his workday, using the various portlets, and the software tools embedded within each portlet, to accomplish his assignments and activities. From filling out forms, to contacting suppliers, to awarding contracts and managing the contract lifecycle, the ESMP can provide a single “desktop” feature which ties individual employee performance and work to department and enterprise business policies, practices, and standards. Through the ESMP, an audit of structured and unstructured content and data may be performed that may allow the USPS™ to gain visibility into its workforce behavior, as well as provide information for audit and government oversight purposes.

As in the previous example, it is contemplated that a supply management manager of the USPS™ may also be able to log into the ESMP every morning to conduct business. Besides the regular portlets that enable him to work from his desktop, the manager may also be able to evaluate the performance of contracts, employees, and suppliers in his commodity group or across the USPS™ using the system and method of the present invention. Based upon his access level, he may have the ability to see recent activity in various areas, as well as manage projects and initiatives with greater visibility and with less manual processes than with conventional supply management work processes.

With the systems and methods provided, decisions and risk analysis may be performed through several tools that make up the “Strategic Sourcing” function. For example, managers in supply management may use the system of the present invention to speak with their contracting officers and their teams to view their current supplier mix in a particular area, or examine different options through advanced analysis software to compare various supplier profiles and performances. Furthermore, managers may use the system to view documents generated by their employees and add edits to comply with current or new policies and procedures. In addition, managers may use the system to collaborate directly with suppliers and other USPS™ personnel to maximize the effectiveness of USPS™ Supplier Relationship Management (SRM). Workflows across various USPS™ supply management functions may be changed by one or more managers with the approval of the Vice President of Supply Management to promote more efficient processes. The ESMP may immediately implement these new processes through the flexibility of the eCommerce Portal and its integration of four key functions: Supplier Relationship Management 120, Strategic Sourcing 110, Business Intelligence 125, and Collaboration Access 115.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended that the specification and examples be considered as exemplary only, with a true scope and spirit of the invention being indicated by the following claims.

What is claimed is:

1. A method for managing an enterprise supply, the method comprising:
providing an enterprise management supply portal comprising an eCommerce module configured to use a plurality of sub-modules to provide an integrated online application environment, a collaboration access module configured to receive voice data, and a portal database configured to store data relating to contracts between suppliers and an enterprise;
accessing data for a contract from the portal database using the eCommerce module;
receiving voice data with the collaboration module;
integrating the voice data with accessed data from the portal database; and
executing a business decision relating to the contract based on the integrated data.

2. The method of claim 1, wherein the accessed data stored in the portal database comprises at least one of voice data, keyed data, electronic data, or web-based data.

3. The method of claim 1, wherein the portal further comprises a strategic sourcing module configured to provide decision support and analysis.

4. The method of claim 1, wherein the portal further comprises a supplier relationship management module configured to provide supplier relationship management between the supplier and the enterprise.

5. The method of claim 1, wherein the portal further comprises a business intelligence module configured to provide management of documents and content within the portal.

6. The method of claim 1, further including the step of registering the supplier using the eCommerce module.

7. The method of claim 6, wherein the step of registering includes the step of providing a voiceprint identification for that supplier.

8. The method of claim 1, further including the step of managing an activity relating to the contract.

9. The method of claim 8, wherein the step of managing comprises viewing the current contract status.

10. The method of claim 8, wherein the step of managing comprises managing the contract lifecycle.

11. The method of claim 8, wherein the step of managing comprises at least one of viewing or editing the contract's financial status.

12. The method of claim 8, wherein the step of managing comprises at least one of viewing, setting, editing, or deleting an event relating to that contract.

13. The method of claim 8, wherein the step of managing comprises at least one of creating, viewing, editing, or deleting a document relating to that contract.

14. The method of claim 1, further including the step of having an online discussion with a supplier.

15. The method of claim 1, further including the step of generating a contract using a contract creation application linked to the eCommerce module.

16. The method of claim 1, further including the step of placing a catalog purchase order using the portal.

17. The method of claim 1, further including the step of bidding on an available contract using the portal.

18. The method of claim 1, further including the step of performing an analysis of an existing contract using the portal.

19. The method of claim 18, wherein the analysis comprises evaluating a supplier's performance.

20. The method of claim 1, further including the step of building communities of practice using the portal.

21. A system for enterprise supply management comprising:
an enterprise supply management portal comprising a memory storage for maintaining a database and a processing unit coupled to the memory storage, the database being configured to store data relating to contracts between suppliers and an enterprise;
an eCommerce module for use with the processing unit and being configured to use a plurality of sub-modules to provide an integrated online application environment; and
a collaboration access module for use with the processing unit and being configured to receive voice data;
the system being configured to integrate voice data with data from the database, and to execute a business decision relating to the contract based on the integrated data.

22. The system of claim 21, wherein the data from the database comprises at least one of voice data, keyed data, electronic data, or web-based data.

23. The system of claim 21, further including a strategic sourcing module for use with the processing unit and being configured to provide decision support and analysis.

24. The system of claim 21, further including a supplier relationship management module for use with the processing unit and being configured to provide supplier relationship management between a supplier and an enterprise; and

25. The system of claim 21, further including a business intelligence module for use with the processing unit and being configured to provide management of documents and content within the enterprise supply management portal.

26. The system of claim 21, further including a screen to allow self-registration of a supplier.

27. The system of claim 26, wherein the self-registration includes a voiceprint identification for that supplier.

28. The system of claim 21, further including a screen for managing an activity relating to a supply contract.

29. The system of claim 28, further including a screen for viewing the current contract status.

30. The system of claim 28, further including a screen for managing the contract lifecycle.

31. The system of claim 28, further including a screen for at least one of viewing or editing the contract's financial status.

32. The system of claim 21, further including a screen for at least one of viewing, setting, editing, or deleting an event relating to that contract.

33. The system of claim 21, further including a screen for at least one of creating, viewing, editing, or deleting a document relating to that contract.

34. The system of claim 21, further being configured to provide an online discussion with a supplier.

35. The system of claim 21, further including a contract creation application for generating a contract.

36. The system of claim 21, further including an online catalog database for ordering supplies.

37. The system of claim 21, further including an auction system for bidding on an available contract.

38. The system of claim 21, further being configured to perform an analysis of an existing contract.

39. The system of claim 38, wherein the analysis comprises an evaluation of a supplier's performance.

40. The system of claim 21, further being configured to build communities of practice.

41. The system of claim 21, further being configured to receive or transmit data with a wire line communications system.

42. The system of claim 21, further being configured to receive or transmit data with a wireless communications system.
